(19) United States
(12) Patent Application Publication
(10) Pub. No.: US 2009/0194604 A1
(43) Pub. Date: Aug. 6, 2009

(54) Pulsed spray system of reduced power consumption

(76) Inventor: Clyde Meriwether Smith, Nashville, TN (US)

Correspondence Address: Clyde Meriwether Smith, 5945 Long Meadow Rd, Nashville, TN, 37205, US

(21) Appl. No.: 12/321,200

(22) Filed: Jan. 20, 2009

Related U.S. Application Data
(60) Provisional application No. 61/011,582, filed on Jan. 19, 2008.

(51) Int. Cl. B05B 17/00; F02M 45/00

(52) U.S. Cl. 239/1; 239/533.4

(57) ABSTRACT

A system for spraying fluids at variable flow rate using pulse width modulation utilizing a circuit including a reservoir, pump, spray nozzle, pulse width modulated valve. While no spray issues from a nozzle, the fluid circuit is closed with the reservoir as the initial and end point of the circuit. While no spray issues from a nozzle, the fluid flow through a heated nozzle functions as a heat sink. While spray issues from a nozzle, the circuit contains a means to maintain a specific fluid pressure. While no spray issues from a nozzle, the circuit pressure is much lower than the spray pressure allowing reduced energy consumption and lessening wear on the pump and motor. This system may be incorporated into a selective catalytic reduction (SCR) system for controlling NOX emissions from diesel engines using a urea-water solution as a fluid.

### FIELD OF THE INVENTION

The present invention relates generally to mobile equipment where fluid is dispensed as a intermittent spray. More particularly, the present invention relates to hydraulic circuit of the spray system where the spray rate is controlled by pulse width modulated and there is benefit to reducing the average power consumption of the motor that drives the spray pump. Applications include pollution control such as SCR (selective catalytic reduction) emission control on diesel engines and agricultural uses such as pest control and fertilizer application.

### BACKGROUND OF THE INVENTION

Many types of equipment use include a means for pumping a fluid from a reservoir and spraying it from one or more nozzles. A paint spray gun is such an example. From a control point of view, a steady state condition where the flow is constant is the simplest case. However, adaptive control is most often needed for reasons of performance and/or economy. Typically, varying the flow rate through the nozzle is not a good adaptive control since the droplet size is affected with attendant consequences on performance and/or economy. Other means such as multiple passes, selective operation of multiple nozzles, varying the relative speed (and/or distance) of the nozzle to destination, air atomization, or pulse width modulation are more often used and with less effect on droplet size. For the present invention, attention is directed toward pulse width modulation means.

### SUMMARY OF THE INVENTION

In one aspect of the invention, a hydraulic circuit is disclosed that includes at least fluid source, a fluid destination, a fluid pressurizing means and a fluid flow interrupter means. Typically, this circuit will have an atmospheric pressure fluid reservoir, a spray nozzle, a electric motor driven pump and a ON/OFF, electrically operated modulating valve. Because the present invention has a purpose of reducing the average power consumption and wear on pump and motor, the invention anticipates that more benefit accrues in applications where spray from the nozzle is more off than on. The circuit arrangement and components are comprised to achieve a low pressure differential across the pump when there is no demand for spray. It is the low pressure differential that is related to the lowered average power consumption and wear. A lower average power consumption may be important because of generator or alternator limitations on mobile equipment. Whereas peak power consumption may not be a limitation because of the high instantaneous power capability of a battery.

It is object of the present invention to provide a constant pressure for a spray nozzle by use of a fixed orifice and a pressure responsive variable speed pump.

It is another object of the present invention to provide a constant pressure for a spray nozzle by use a pressure responsive variable orifice and a constant speed pump.

It is another object of the present invention to provide a constant pressure for a spray nozzle and compensate for pump performance degradation due to wear.

It is another object of the present invention to a constant and higher pressure for the nozzle in the circuit only when a spray pulse from a nozzle is required.

The above objects are exemplary only, and this invention contemplates devices and systems that may meet or fulfill one or more of these objects. Additional objects and advantages of the invention will be set forth in part in the description which follows, and in part will be obvious from the description, or may be learned by practice of the invention. In addition to the structural and procedural arrangements set forth above, the invention could include a number of other arrangements such as those explained hereinafter. It is to be understood that both the foregoing general description and the following detailed description are exemplary only.

### BRIEF DESCRIPTION OF THE DRAWINGS

The accompanying drawings, which are incorporated in and constitute a part of this specification, illustrate embodiments of the invention and together with the description, serve to explain some principles of the invention.

FIG. 1 is an exemplary schematic representation describing a hydraulic circuit using a fixed orifice and variable speed pump.

FIG. 2 is an exemplary schematic representation describing a hydraulic circuit using a variable orifice and fixed pump motor.

### DESCRIPTION OF THE EMBODIMENTS

Reference will now be made in detail to exemplary embodiments of the invention, an example of which is illustrated in the accompanying drawings. Wherever possible, the same reference numbers will be used throughout the drawings to refer to the same or like parts.

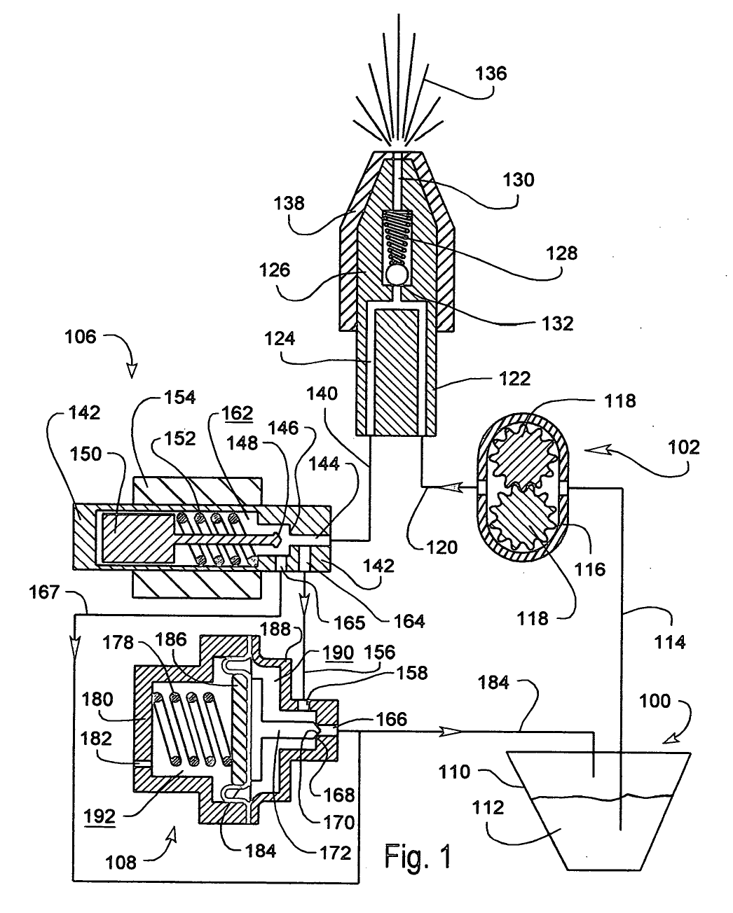

FIG. 1 is an exemplary schematic representation describing a fluid circuit using a variable orifice and fixed speed pump. A circuit consists of reservoir 100 as the origin communicating through line 114 to pump 102, then communicating through line 120 to spray nozzle 104 then communicating through line 140 to pulse width modulating valve 106, then communicating through line 156 to back pressure regulator 108, and then communicating through line 184 to reservoir 100 as the destination. During normal operation, a portion of a fluid flowing in this circuit is ejected as a spray 136. Back pressure regulator 108 maintains a predetermined spray pressure.

The following detail is directed toward describing a circuit may exist imbedded in a larger system such as a selective catalytic reduction SCR emission control system for treatment of diesel exhaust for NOX reduction. A reservoir 100 includes a container 110 and a fluid 112 at atmospheric pressure. A gear pump 102 includes rotating gears 118 in housing 116 where line 114 connects to pump inlet and line 120 connects to pump outlet. A spray nozzle 104 includes nozzle housing 122 with cooling and supply passageway 124, and insulator jacket 138. An element of passageway terminates at relief valve seat 132. Relief valve seat 132 is intermittently blocked by relief valve ball 126 that is biased toward blockage by spring 128. Blockage is in effect up to a predetermined pressure at which and above blockage is not in effect as fluid pressure overcomes spring pressure. Spray orifice 130 provides an exit for a fluid 112 as a spray 136 and intermittently communicates with passageway 124. A pulse width modulating valve 105 includes a housing 142 with inlet passageway 144 and outlet passageway 164. Communication of passageway 144 to chamber 162 is intermittently blocked by poppet 148 on seat 146. Poppet 148 is an element of plunger 150. Plunger 150 is biased by spring 152. An electromagnetic force provided by energized coil 154 acts on plunger 150 counter to spring 152. The electromagnetic force on plunger 150 is sufficient to overcome the force of spring 152 and the force of fluid pressure against poppet 146. This electromagnetic valve is energized by a controller (not shown) and is closed when energized. Fluid may leave valve 105 by an intermittently blocked fluid path through line 167 for return to reservoir 100. Fluid may leave valve 105 by a non-blocked fluid path through line 165 to back pressure relief valve 108. A back pressure valve 108 includes housing segment 180 and housing segment 188. Valve 105 is divided by diaphragm 184 into 2 chambers. One chamber 192 includes spring 178 bearing against housing 180 and poppet backer plate 186. Chamber 192 remains at atmospheric pressure since it communicates with the atmosphere through passageway 182. Chamber 190 includes poppet 172. Fluid enter chamber 190 through passageway 158 from line 156. Fluid exits chamber 190 through passageway 166 and then into line 184 for return to reservoir 100. Fluid flow from chamber 190 to passageway 166 is intermittently blocked by poppet face 170 when it rests on poppet seat 168 of passageway 166. When the fluid pressure in chamber 190 exerts a countering force on poppet greater than the spring force on poppet 172, then poppet face 170 lifts off of seat 168 allowing fluid flow from chamber 190 into passageway 166.

In operation, a fluid in reservoir 100 may be a solution including water and urea. While pump 102 is running, a fluid enters pump 102 where a pump maintains a pressure differential with the pressure of line 120 higher than the pressure of line 114. A nominal pressure in line 114 may be atmospheric. Because the circuit described may be in two discrete states (spraying or not spraying), a fluid in line 120 may be at a lower circulating pressure or a higher spraying pressure. For example, a spraying pressure may be 90 psi and a circulating pressure may be 10 psi. A fluid exits pump 102 through line 120 to spray nozzle 104. Fluid circulates through nozzle 104 to provide heat removal in the case where a nozzle is located in a diesel exhaust stream. Fluid also circulates because pump 102 needs to be running to supply fluid for spraying without the delay of starting and stopping. A portion of a fluid flow into nozzle 104 exits intermittently as a spray 136 with the balance returning to reservoir 100 by means of a return circuit comprised of line 140 modulating valve 106 lines 167 and 156, regulator 108 and line 184. A spray 136 will exit nozzle 104 when fluid resistance increases down stream of nozzle 104 because of the operation of valve 106 and regulator 108. When conditions require a pulse of spray as determined by a system controller, coil 154 of valve 106 is energized for the duration of the required pulse. Energized coil 154 acts on plunger 150 and compresses spring 152. Poppet 148 closes on seat 146 thereby blocking flow from passageway 144 to chamber 162. With this blockage, the free flow of fluid to reservoir 100 ends and all flow is directed to regulator 108 through passageway 164 and line 156. Regulator 108 allows a fluid to proceed to reservoir 100 yet provides resistance to achieve a predetermine pressure, such as 90 psi. A fluid enters chamber 190 of regulator 108 through line 156 and passageway 158. Initially, a fluid entering chamber 190 may not exit to reservoir 100 because of blockage by poppet face 170 resting on seat 168. Instead, the increasing volume of chamber 190 lifts poppet 170 off of seat 168 allowing a fluid to exit through passageway 166 and line 184 to reservoir 100. When conditions require no spray, coil 154 of valve 106 is de-energized. 152 acts on plunger 150 to lift poppet 148 off of seat 146 and allow free flow of a fluid from passageway 144 through chamber 162, through passageway 165, through line 167, joining with line 184 and finally into reservoir 100. Since this portion of the circuit is designed with low resistance, at for example 10 psi, this is the preferential fluid path. The path through regulator 108 is blocked because the fluid pressure is insufficient to life poppet 170 off of seat 168.

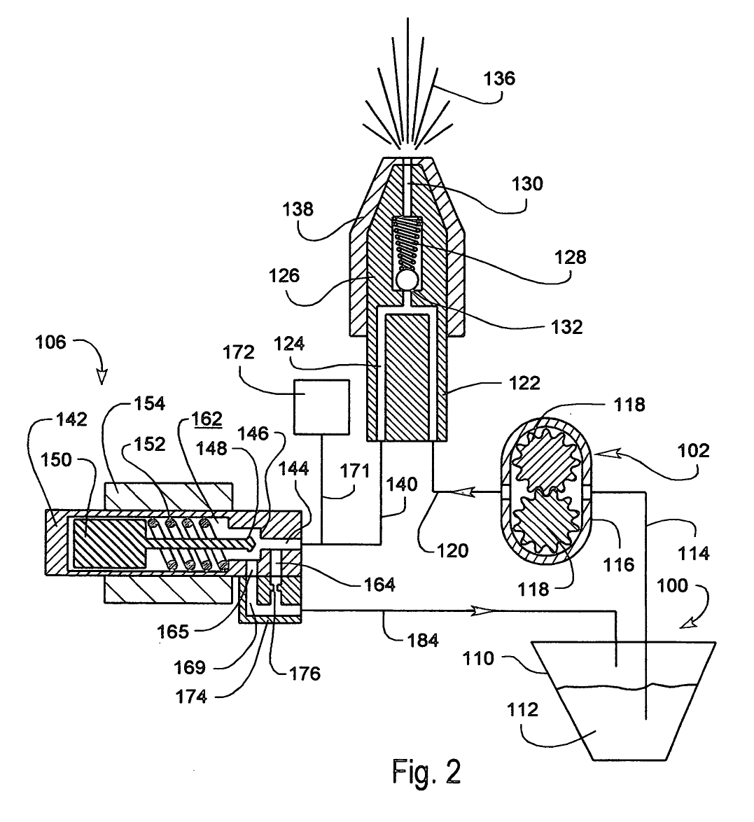

FIG. 2 is an exemplary schematic representation describing a fluid circuit using a fixed orifice and variable speed pump. A circuit consists of reservoir 100 as the origin communicating through line 114 to pump 102, then communicating through line 120 to spray nozzle 104 then communicating through line 140 to pulse width modulating valve 106 with fixed orifice, and then communicating through line 184 to reservoir 100 as the destination. During normal operation, a portion of a fluid flowing in this circuit is ejected as a spray 136. A pressure sensing means 172 with control means (not shown) operates a motor (not shown) of pump 102 so that pump 102 is responsive to pressure as measured by pressure sensor means 172 to maintain a predetermined pressure. Pump 102 may be operated in reverse rotation to purge the circuit of fluid for an exemplary purpose of freeze protection.

The following detail is directed toward describing a circuit may exist imbedded in a larger system such as a selective catalytic reduction SCR emission control system for treatment of diesel exhaust for NOX reduction. A reservoir 100 includes a container 110 and a fluid 112 at atmospheric pressure. A gear pump 102 includes rotating gears 118 in housing 116 where line 114 connects to pump inlet and line 120 connects to pump outlet. A spray nozzle 104 includes nozzle housing 122 with cooling and supply passageway 124, and insulator jacket 138. An element of passageway terminates at relief valve seat 132. Relief valve seat 132 is intermittently blocked by relief valve ball 126 that is biased toward blockage by spring 128. Blockage is in effect up to a predetermined pressure at which and above blockage is not in effect as fluid pressure overcomes spring pressure. Spray orifice 130 provides an exit for a fluid 112 as a spray 136 and intermittently communicates with passageway 124. A pulse width modulating valve 105 includes a housing 142 with inlet passageway 144 and outlet passageway 164. Communication of passageway 144 to chamber 162 is intermittently blocked by poppet 148 on seat 146. Poppet 148 is an element of plunger 150. Plunger 150 is biased by spring 152. An electromagnetic force provided by energized coil 154 acts on plunger 150 counter to spring 152. The electromagnetic force on plunger 150 is sufficient to overcome the force of spring 152 and the force of fluid pressure against poppet 146. This electromagnetic valve is energized by a controller (not shown) and is closed when energized. Fluid may leave valve 105 by an intermittently blocked fluid path through passageway 165 and passageway 169 for return to reservoir 100 through line 184. Fluid may leave valve 105 by a non-blocked fluid path through passageway 164 to orifice 176 to passageway 169 and through line 184 back to reservoir 100.

In operation, a fluid in reservoir 100 may be a solution including water and urea. While pump 102 is running, a fluid enters pump 102 where a pump maintains a pressure differential with the pressure of line 120 higher than the pressure of line 114. A nominal pressure in line 114 may be atmospheric. Because the circuit described may be in two discrete states (spraying or not spraying), a fluid in line 120 may be at a lower circulating pressure or a higher spraying pressure. For example, a spraying pressure may be 90 psi and a circulating pressure may be 10 psi. A fluid exits pump 102 through line 120 to spray nozzle 104. Fluid circulates through nozzle 104 to provide heat removal in the case where a nozzle is located in a diesel exhaust stream. Fluid also circulates because pump 102 needs to be running to supply fluid for spraying without the delay of starting and stopping. A portion of a fluid flow into nozzle 104 exits intermittently as a spray 136 with the balance returning to reservoir 100 by means of a return circuit comprised of line 140 modulating valve 106, and line 184. A spray 136 will exit nozzle 104 when fluid resistance increases down stream of nozzle 104 because of the operation of valve 106 and the effect of orifice 176. When conditions require a pulse of spray as determined by a system controller, coil 154 of valve 106 is energized for the duration of the required pulse. Energized coil 154 acts on plunger 150 and compresses spring 152. Poppet 148 closes on seat 146 thereby blocking flow from passageway 144 to chamber 162. With this blockage, the free flow of fluid to reservoir 100 ends and all flow is directed through passageway 164, then orifice 176, passageway 169 and line 184. Orifice 176 allows a fluid to proceed to reservoir 100 yet provides resistance to achieve a predetermine pressure, such as 90 psi. When conditions require no spray, coil 154 of valve 106 is de-energized. 152 acts on plunger 150 to lift poppet 148 off of seat 146 and allow free flow of a fluid from passageway 144 through chamber 162, through passageway 169, through line 184, and finally into reservoir 100. Since this portion of the circuit is designed with low resistance, at for example 10 psi, this is the preferential fluid path.

For the purpose of spray distribution, it may be advantageous to use a plurality of spray nozzles.

It will be apparent to those skilled in the art that various modifications and variations can be made to the structure and methodology described herein. Thus, it should be understood that the invention is not limited to the examples discussed in the specification. Rather, the present invention is intended to cover modifications and variations.

What is claimed is:

1. A system for spraying a fluid at variable flow rates, the system comprising:
a fluid reservoir in flow communication by passageway to a pump;
said pump in flow communication by passageway to a spray nozzle;
said spray nozzle in flow communication by passageway to a two position, solenoid valve;
said solenoid valve being responsive to a controller utilizing pulse width modulation; and
said solenoid valve in flow communication by passageway to said fluid reservoir,
wherein said spray nozzle contains a positionally biased one way valve responsive to a fluid pressure change,
wherein said fluid pressure change consist of an alternation of said fluid pressure between a low and high pressure state responsive to operation of said solenoid valve,
wherein a high pressure state overcomes the positional bias of said one way valve allowing the fluid to spray from said nozzle, and
whereby establishment of a intermittent low pressure state enables a reduction in average power consumption and wear of the pump.

2. The system of claim 1, further comprising a low fluid pressure state passageway and a high fluid pressure state passageway from the spray nozzle to the fluid reservoir and where said low pressure state passageway is intermittently blocked by the solenoid valve making only said high pressure state passageway open for fluid flow.

3. The system of claim 1, wherein the high pressure state is maintained at a predetermined value by a pressure regulating means.

4. The system of claim 3, wherein the pressure regulating means to maintain a predetermined high pressure state is achieved by a variable speed pump responsive to a controller with pressure sensor.

5. The system of claim 3, wherein the pressure regulating means to maintain a predetermined high pressure state is achieved by a back pressure regulator device.

6. The system of claim 1, wherein a plurality of nozzles are used that spray simultaneously.

7. The system of claim 1, wherein the solenoid valve is located remotely downstream of the spray nozzle.

8. The system of claim 1, wherein the sprayed fluid is a solution of water and urea in a selective catalytic reduction emission control system for diesel engines.

9. A method of spraying a fluid, the method comprising:
providing a fluid circulating loop comprising a reservoir, pump, spray nozzle, solenoid valve, and connecting passageways;
providing a loop segment that alternates between a high pressure and low pressure state;
providing a spray nozzle within said loop segment wherein said nozzle emits said fluid only during said high pressure state; and
establishing an intermittent high pressure state by providing a passageway blocking device that alternates between a closed and open state responsive to a controller means providing an electrical power signal to said blocking device.

10. A method of claim 9, further comprising a variable speed pump motor responsive to high pressure state and responsive to pump performance degradation due to wear.

11. A method of claim 9, further comprising a variable flow restriction device responsive to high pressure state and responsive to pump performance degradation due to wear.
